(19) United States
(12) Patent Application Publication
(10) Pub. No.: US 2018/0188713 A1
(43) Pub. Date: Jul. 5, 2018

(54) Method and Apparatus for Automatically Maintaining Very Large Scale of Machines

(71) Applicant: BEIJING BAIDU NETCOM SCIENCE AND TECHNOLOGY CO., LTD., Beijing (CN)

(72) Inventors: Zhiguang Hu, Beijing (CN); You Zhang, Beijing (CN); Da Hu, Beijing (CN)

(73) Assignee: BEIJING BAIDU NETCOM SCIENCE AND TECHNOLOGY CO., LTD., Beijing (CN)

(21) Appl. No.: 15/862,508

(22) Filed: Jan. 4, 2018

(30) Foreign Application Priority Data
Jan. 4, 2017 (CN) 201710005057.4

(51) Int. Cl. G05B 19/418; G06F 11/22; G05B 19/4063

(52) U.S. Cl. CPC G05B 19/4183; G06F 11/22; G05B 19/4185; G05B 19/41845; G05B 19/4184; G05B 19/41835; G05B 19/4063

(57) ABSTRACT

An objective of the present disclosure is to provide a method and an apparatus for automatically maintaining a very large scale of machines. Compared with the prior art, the present disclosure collects software and/or hardware errors in a very large scale of machines; performs error analysis to the software and/or hardware errors to obtain corresponding error data; based on the error data, turns over respective states using a maintenance state machine to complete the automated maintenance of the very large scale of machines, wherein machines corresponding to the data that need to be relocated are subjected to whole-machine relocation maintenance, and the machines corresponding to the storage-type service are subjected to online disk repair.

### CROSS-REFERENCE TO RELATED APPLICATIONS

This application is related to and claims priority from Chinese patent application no. 201710005057.4, filed with the state intellectual property office (SIPO) of the People's Republic of China on Jan. 4, 2017, the entire disclosure of the Chinese application is hereby incorporated by reference.

### TECHNICAL FIELD

The present disclosure relates to the field of computer technologies, and more particularly to a technology for automatically maintaining a very large scale of machines.

### BACKGROUND

The existing machine maintenance generally has the following scenarios:

1) in the case of a small scale (dozens of machines), the maintenance and handover is usually done by operation and maintenance staff through monitoring or manual monitoring;

2) in the case of medium and large scales (hundreds or thousands of machines), the maintenance and handover is usually implemented by monitoring+script or by a small automation system.

However, for a very large scale (tens of thousands, even hundreds of thousands) of machines, issues such as human resources cost and maintenance handover efficiency will arise.

The following are several typical implementation schemes of automated maintenance in the prior art:

1) a script-type maintenance system: it is generally a solution for a small-scale cluster. Such clusters are even possibly not completely virtualized. This system typically manipulates the machines by monitoring, by deploying a tool relocation service, or by triggering a service API command. Although it is simple and easily developed, it does not have a fixed collection and analysis system. The script-type maintenance system is generally deployed for some simple maintenance scenarios. Due to its simple functions, it is not applicable for a large-scale system.

2) a triggered-type maintenance system: it may also be referred to as a semi-automated maintenance system. It generally has an independent collector to collect errors and grades the errors, and also has a set of independent error pool and maintenance push system. The triggered-type maintenance system satisfies demands of most maintenance systems, but still has drawbacks that an independent service relocation interchanging service is not provided, and an interacting procedure is absent because when an error occurs, such that a user has to retrieve an autonomous error push.

However, these existing maintenance solutions cannot satisfy versatile requirements, let alone satisfying the requirements of a very large scale of machines. Most of the maintenance systems are only directed to uniform machine models, systems, and environments. However, in practical operations, it is needed to consider the versatility of machine models as well as the versatility of transactions, and it is also needed to satisfy different transaction demands and systems, e.g., different configurations and environments regarding storage, computation, etc.

Therefore, it becomes an imminent problem to those skilled in the art to resolve how to provide a method and an apparatus for automatically maintaining a very large scale of machines.

### SUMMARY

An objective of the present disclosure is to provide a method and an apparatus for automatically maintaining a very large scale of machines.

According to one aspect of the present invention, there is provided a method for automatically maintaining a very large scale of machines, comprising:

collecting software and/or hardware errors in the very large scale of machines;

performing error analysis to the software and/or hardware errors to obtain corresponding error data;

turning over respective states using a maintenance state machine based on the error data to complete automated maintenance of the very large scale of machines, wherein machines corresponding to data that need to be relocated are subjected to whole-machine relocation maintenance, and machines corresponding to a storage-type service are subjected to online disk repair.

Preferably, collecting software and/or hardware errors comprises:

obtaining the software and/or hardware errors based on software detection and/or hardware detection on the very large scale of machines, and reporting the software and/or hardware errors to a master service end;

wherein, performing error analysis comprises:

performing error analysis to the software and/or hardware errors in the master service end to obtain corresponding error data.

Preferably, the method further comprises:

establishing or updating a corresponding data center using the error data obtained from performing error analysis to the software and/or hardware errors as an error source;

wherein, turning over respective states comprises:

turning over respective states using the maintenance state machine based on the error source in the datacenter to complete automated maintenance of the very large scale of machines.

Preferably, performing error analysis further comprises:

classifying the error data obtained through the error analysis to obtain classified error data;

wherein, turning over respective states comprises:

turning over respective states using the maintenance state machine based on the classified error data to complete automated maintenance of the very large scale of machines.

Preferably, turning over respective states comprises:

turning over respective states using the maintenance state machine based on the classified error data in conjunction with a threshold corresponding to configuration information to complete automated maintenance of the very large scale of machines.

Preferably, turning over respective states comprises:

performing whole-machine relocation maintenance to machines corresponding to the data that need to be relocated using a general relocation service platform; and

for the machines remained after relocation, continuing turning over respective states using the maintenance state machine to perform automated maintenance.

Preferably, turning over respective states comprises:

for the machines corresponding to a storage-type service, deciding whether to decommit disks using a single-disk central control, so as to perform online disk repair to the machines.

According to another aspect of the present invention, there is provided an apparatus for automatically maintaining a very large scale of machines, comprising:

an error collecting module configured to collect software and/or hardware errors in the very large scale of machines;

an error analyzing module configured to perform error analysis to the software and/or hardware errors to obtain corresponding error data;

an error maintaining module configured to turn over respective states using a maintenance state machine based on the error data to complete automated maintenance of the very large scale of machines, wherein machines corresponding to data that need to be relocated are subjected to whole-machine relocation maintenance, and machines corresponding to a storage-type service are subjected to online disk repair.

Preferably, the error collecting module is configured to:

obtain the software and/or hardware errors based on software detection and/or hardware detection on the very large scale of machines, and report the software and/or hardware errors to a master service end;

wherein, the error analyzing module is configured to:

perform error analysis to the software and/or hardware errors in the master service end to obtain corresponding error data.

Preferably, the apparatus further comprises:

an updating module configured to establish or update a corresponding data center using the error data obtained from performing error analysis to the software and/or hardware errors as an error source;

wherein, the error maintaining module is configured to:

turn over respective states using the maintenance state machine based on the error source in the datacenter to complete automated maintenance of the very large scale of machines.

Preferably, the error analyzing module is further configured to:

classify the error data obtained through the error analysis to obtain classified error data;

wherein, the error maintaining module is configured to:

turn over respective states using the maintenance state machine based on the classified error data to complete automated maintenance of the very large scale of machines.

Preferably, the error maintaining module is configured to:

turn over respective states using the maintenance state machine based on the classified error data in conjunction with a threshold corresponding to configuration information to complete automated maintenance of the very large scale of machines.

Preferably, the error maintaining module is configured to:

perform whole-machine relocation maintenance to machines corresponding to the data that need to be relocated using a general relocation service platform; and

for the machines remained after relocation, continue turning over respective states using the maintenance state machine to perform automated maintenance.

Preferably, the error maintaining module comprises:

for the machines corresponding to a storage-type service, decide whether to decommit disks using a single-disk central control, so as to perform online disk repair to the machines.

According to another aspect of the present invention, there is provided a computer device, comprising:

one or more processors;

a memory for storing one or more computer programs; and

when the one or more computer programs are executed by the one or more processors, the one or more processors are caused to implement the method according to any one above.

Compared with the prior art, the present disclosure collects software and/or hardware errors in a very large scale of machines; performs error analysis to the software and/or hardware errors to obtain corresponding error data; based on the error data, turns over respective states using a maintenance state machine to complete the automated maintenance of the very large scale of machines, wherein machines corresponding to the data that need to be relocated are subjected to whole-machine relocation maintenance, and the machines corresponding to the storage-type service are subjected to online disk repair. For a very large scale (tens of thousands, hundreds of thousands) of machines, the present disclosure provides a complete and automated maintenance system, which may satisfy error detection, service relocation, environment deployment, machine maintenance state turnover, fast handover, and etc. In the aspect of cost, the present disclosure reduces manpower for operation and maintenance and saves machines by enhancing turnover efficiency; in the aspect of full automation, the present disclosure realizes full automation in detection, maintenance, service relocation and deployment, without a need of human intervention; in the aspect of efficiency, the present disclosure has an efficient machine handover, which may achieve an hour-level or even minute-level handover.

Further, the present disclosure may satisfy system and environment supports in a plurality of scenarios and may also satisfy the scenarios of online machine maintaining and automated machine maintaining for transactions in an offline mixed deployment scenario. With the increasing number of machines, the present disclosure may also satisfy efficient machine turnover and handover, and satisfy transaction use; the present disclosure may be constantly horizontally scaled, and has a capability of quick handover, e.g., the capacity expansion may be completed at a minute level, reinstallation or rebooting may be completed at an hour-level, and maintenance may be completed at a day-level; moreover, the present disclosure may satisfy high-performance operations of tens of thousands of machines.

Further, the present disclosure performs hot-plug hard disk maintenance for a storage-type service and provides a set of controllable single disk central control service to guarantee the number of disks off, thereby guaranteeing safe and quick handover, maintenance and relocation.

In addition, the present disclosure enhances the online utilization of the machines by accelerating the machine maintenance with an improved time-efficiency, which may save resources of the machines, e.g., if previously, the error rate was 2%, the online rate was 98%, and the total number of machines was 100,000, then there would be 2,000 machines which were continuously unusable; therefore, 2000 machines were subjected to redundant backup. Supposing the machine error rate can be reduced to 1% after enhancing the maintenance efficiency, the online rate may reach 99%; and then the number of continuously error machines will be reduced by 1000, which means 1000 machines are reduced for redundancy backup, and so forth. Further, the errors being discovered in advance may reduce machine service loss; alarming and processing in advance may also avoid traffic loss due to machine unavailability caused by machine crash and hardware error.

The present disclosure may facilitate a cluster operating system to support stability of underlying machines and may discover errors, relocate services and efficiently hand over the machines in real time. The present disclosure achieves a real robot for automatic machine management, realizes no human intervention, and much improves error type accuracy; for example, by adding soft error and crash, etc., it guarantees a more stable service; it may predict errors for repair, which guarantees service stability; the efficient handover may implement an efficient automation system that achieves minute-level machine committing, hour-level machine capacity expansion (including reinstallation), and hour-level software repair and machine handover, and day-level handover of hardware error machines.

### BRIEF DESCRIPTION OF THE ACCOMPANYING DRAWINGS

Other features, objectives and advantages of the present invention will become more apparent through reading the detailed depiction of the non-limiting embodiments with reference to the accompanying drawings:

FIG. 1 shows a structural diagram of an apparatus for automatically maintaining a very large scale of machines according to an aspect of the present disclosure;

FIG. 2 shows a structural diagram of an apparatus for automatically maintaining a very large scale of machines according to an embodiment of the present disclosure;

FIG. 3 shows a structural diagram of an apparatus for automatically maintaining a very large scale of machines according to another embodiment of the present disclosure;

FIG. 4 shows a flow diagram of a method for automatically maintaining a very large scale of machines according to another aspect of the present disclosure.

In the drawings, same or like reference numerals represent same or similar components.

### DETAILED DESCRIPTION OF EMBODIMENTS

Before discussing the exemplary embodiments in more details, it should be noted that some exemplary embodiments are described as processes or methods depicted as flow diagrams. Although the flow diagrams describe various operations as sequential processing, many operations therein may be implemented in parallel, concurrently or simultaneously. Besides, the sequence of various operations may be re-arranged. When the operations are completed, the processing may be terminated; besides, there may also include additional steps that are not included in the drawings. The processing may correspond to a method, a function, a specification, a sub-routine, a sub-program, etc.

The “computer device” herein (also referred to as “the computer”) refers to a smart electronic device that may execute a predetermined processing process such as numerical computation and/or logic computation by running a predetermined program or instruction, which may comprise a processor and a memory, wherein the processor executes a program instruction pre-stored in the memory to execute the predetermined processing process, or executes the predetermined processing process using hardware such as ASIC, FPGA, and DSP, or executes by the combination of the two above. The computer device includes, but not limited to, a server, a personal computer (PC), a laptop computer, a tablet computer, a smart phone, and etc.

The computer device for example includes a user equipment and a network device. Particularly, the user equipment includes, but not limited to, a personal computer (PC), a laptop computer, and a mobile terminal, etc.; the mobile terminal includes, but not limited to, a smart phone, a PDA, and etc.; the network device includes, but not limited to, a single network server, a server group consisting of a plurality of network servers, or a cloud consisting a large number of computers or network servers based on cloud computing, wherein the cloud computing is a kind of distributed computing, i.e., a hypervisor consisting of a group of loosely coupled computer sets. Particularly, the computer device may operate to implement the present invention individually or may access to a network to implement the present invention through an interactive operation with other computer devices in the network. Particularly, the network where the computer device is located includes, but not limited to, the Internet, a Wide Area Network, a Metropolitan Area Network, a Local Area Network, a VPN network, etc.

It needs to be noted that the user equipment, network device, and network here are only examples, and other existing or future possibly emerging computer devices or networks, if applicable to the present invention, but also may be included within the protection scope of the present invention, which are incorporated here by reference.

The methods that will be discussed infra (some of which will be illustrated through flow diagrams) may be implemented through hardware, software, firmware, middleware, microcode, hardware descriptive language or any combination thereof. When they are implemented using software, firmware, middleware or microcode, the program codes or code segments for implementing essential tasks may be stored in a computer or computer readable medium (e.g., storage medium). (One or more) processors may implement essential tasks.

The specific structures and functional details disclosed here are only representative and intended to describe the exemplary embodiments of the present invention. Further, the present invention may be specifically implemented by a plurality of alternative modes and should not be construed to being only limited to the embodiments illustrated herein.

It should be understood that although terms like “first” and “second” may be used here to describe respective units, these units should not be limited by these terms. Use of these terms is only for distinguishing one unit from another unit. For example, without departing from the scope of exemplary embodiments, a first unit may be referred to as a second unit, and likewise the second unit may be referred to as the first unit. The term “and/or” used here includes any and all combinations of one or more associated items as listed.

It should be understood that when one unit is “connected” or “coupled” to a further unit, it may be directly connected or coupled to the further unit, or an intermediate unit may exist. In contrast, when a unit is “directly connected” or “directly coupled” to a further unit, an intermediate unit does not exist. Other terms (e.g., “disposed between” VS. “directly disposed between,” “adjacent to” VS. “immediately adjacent to,” and the like) for describing a relationship between units should be interpreted in a similar manner.

The term used here is only for describing preferred embodiments, not intended to limit the exemplary embodiments. Unless otherwise indicated, a singular form “a (n)” or “one” used here is also intended to cover plurality. It should also be understood that the terms “comprise” and/or “include” as used here limit the presence of features, integers, steps, operations, units and/or components as stated, but do not exclude presence or addition of one or more other features, integers, steps, operations, units, components and/or combinations.

It should also be mentioned that in some alternative implementations, the functions/actions as mentioned may occur according to the sequences different from what are indicated in the drawings. For example, dependent on the functions/actions as involved, two successively indicated diagrams actually may be executed substantially simultaneously or sometimes may be executed in a reverse order.

Hereinafter, the present disclosure will be described in further detail with reference to the accompanying drawings.

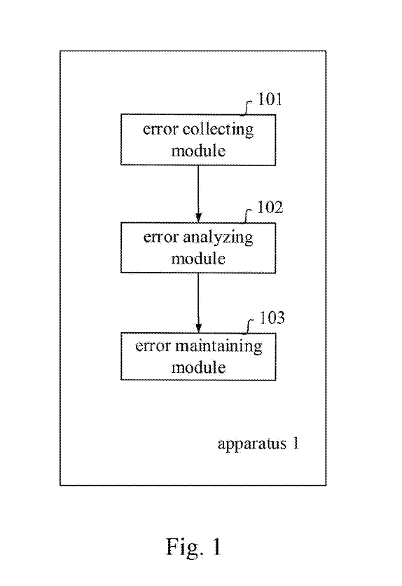

FIG. 1 shows a structural diagram of an apparatus for automatically maintaining a very large scale of machines according to an aspect of the present disclosure.

The apparatus 1 comprises an error collecting module 101, an error analyzing module 102, and an error maintaining module 103.

Particularly, the error collecting module 101 collects software and/or hardware errors in a very large scale of machines.

Specifically, the error collecting module 101 for example directly obtains the software errors and/or hardware errors of the very large scale of machines directly from a predetermined location, e.g., an error datacenter or other third-party devices; or, the error collecting module 101 detects the respective machines constituting the very large scale of machines, e.g., by performing software detection and hardware detection to the respective machines, to detect whether the CPUs, disks, RAMs and the like are healthy or detect whether the disks are already full, whether a disk drops, whether a file system fails, etc., thereby collecting software errors and/or hardware errors in the very large scale of machines.

The error analyzing module 102 performs error analysis to the software and/or hardware errors to obtain corresponding error data.

Specifically, the error analyzing module 102 performs error analysis to these errors based on the software errors and/or hardware errors collected by the error collecting module 101, e.g., analyzing whether the respective machines crash, whether heart beats exist, whether report-no exists, etc., thereby obtaining corresponding error data.

The error maintaining module 103 turns over respective states using a maintenance state machine based on the error data to complete automated maintenance of the very large scale of machines, wherein machines corresponding to the data that need to be relocated are subjected to whole-machine relocation maintenance, while the machines corresponding to the storage-type services are subjected to online disk repair.

Specifically, the error maintaining module 103 employs a maintenance state machine to turn over respective states based on the error data obtained from the analysis by the error analyzing module 102, thereby completing automated maintenance of the very large scale of machines, e.g., turning over respective states such as the machine's crash state, error state, and normal service state, etc., and then performing skipping to respective procedures for the very large scale of machines, e.g., performing skipping to procedures such as error, maintenance, and handover. Particularly, the machines corresponding to the data that need to be relocated are subjected to whole-machine relocation maintenance; because some errors require relocation of the machine where they are located for repairing the remained machines, the error maintaining module 103 relocates the machines corresponding to the data that need relocation and performs whole-machine maintenance to the relocated machine. For a storage-type service, because it is highly demanding on the redundancy and time-efficiency, if a machine corresponding to the storage-type service is subjected to whole-machine relocation maintenance, redundancy and time-efficiency issues will exist; therefore, the error maintaining module 103 performs online disk repair to the machines corresponding to the storage-type service.

Here, the maintenance state machine mainly performs skipping to procedures of machine cycle, e.g., error, maintenance, and handover, etc., wherein the maintenance state machine maintains a plurality of states, e.g., ERROR, DEAD, DECOMMITTING, DECOMMMITED, OS_INSTALL (REBOOT), BURNING, HANDOVER_CHECK, ABNORMAL, COMMITTING, ACTIVE, and etc.; the various states above are used for indicating states of machines in various periods, specifically:

ERROR| DEAD: when an error occurs to a machine, the error will be obtained from the error analyzing module 102; then the maintenance state machine skips to Error, and in the case of crash, skips to DEAD;

DECOMMITTING and DECOMMITTED: it mainly relates to service relocation, for guaranteeing service safety and assigning tasks for errors, e.g., reboot, reinstall, maintenance, etc.

OS_INSTALL (REBOOT): a procedure state for reinstallation or rebooting;

BURNING: a process of environment recovery after reinstallation or rebooting, generally referred to as an initialization environment;

HANDOVER_CHECK and ABNORMAL: HANDOVER_CHECK mainly refers to a secondary check behavior to detect whether a repaired machine still has an error; if the machine is not repaired well, continue to reinstall or reboot. ABNORMAL refers to entering into a manual processing stage if the machine is still not repaired well after exceeding predetermined times.

COMMITTING and ACTIVE: COMMITTING refers to committing the relocated service when no problem is found through handover check and setting the machine to normal ACTIVE.

Here, the error maintaining module 103 controls the states of respective procedures through the maintenance state machine to process different stages, and controls switching between various states through state description, safety protection threshold, retry times, and other contents. The state description is mainly for general processing, suitable for scenarios of various transactions, and thus is a set of state machine adapter. An example of state description is provided below:

state:

ACTIVE:

- action: check_active
dst_state:

- ACTIVE
- DEAD
- ERROR

DEAD:

- action: decommit_host
dst_state: DECOMMITTING

...

thresholds:

state_thresholds:

DECOMMITTED:

threshold: 200
throughput: 100

....

In the table above, state describes a state of the maintenance state machine, e.g., ACTIVE refers to a normal service state; —action refers to an operation in the state processing procedure, e.g., check active refers to checking whether the machine is normal;

dst_state refers to skipping to different target states according to different returned value states in the action so as to control turnover of the maintenance state machine; in the case of crash, skip to DEAD; in the case of error, skip to ERROR.

Preferably, the error maintaining module 103 turns over the respective states using a maintenance state machine based on the error data in conjunction with the threshold corresponding to the configuration information, thereby completing automated maintenance of the very large scale of machines.

For example, in the example of the state description, thresholds are used for controlling thresholds, wherein for controlling the assigned decommitted maintenance, throughput: 100 indicates that the assignment value is controlled not to exceed 100 machines; in the case of exceeding 100 machines, status skipping will not be performed, thereby ensuring safety of the service. Similarly, the error maintaining module 103 may also turn over respective states using the maintenance state machine based on the error data in conjunction with the threshold corresponding to other configuration information, thereby completing automated maintenance of the very large scale of machines.

Those skilled in the art should understand that the threshold and its value are only exemplary; other existing or future possibly emerging thresholds and their values, if applicable to the present disclosure, should also be included within the protection scope of the present disclosure, which are incorporated here by reference.

Preferably, the error maintaining module 103 performs a whole-machine relocation maintenance to the machines corresponding to the data that need to be relocated using a general relocation service platform; for the machines remained after relocation, the maintenance status machine continues turning over respective states to perform automated maintenance.

Specifically, some errors require relocating the machines where they are located so as to maintain the remained machines. Therefore, the error maintaining module 103 relocates the machines corresponding to the data that need to be relocated using a general relocation service platform and performs whole-machine maintenance to the relocated machines. Here, use of the general relocation service platform avoids an occasion that each transaction in different transactions requires maintaining an independent set of relocation services; the general relocation service platform may designate a uniform rule and a uniform policy to facilitate access and maintenance, which is extremely essential for the very large-scale cluster system. Afterwards, the error maintaining module 103 continues using the maintenance state machine for the machines remained after relocation so as to turn over respective states, thereby completing automated maintenance of the very large scale of machines.

Here, the error maintaining module 103 only performs the maintenance procedure after the relocation of service, thereby guaranteeing service stability.

Preferably, for machines corresponding to the storage-type service, the error maintaining module 103 decides whether to decommit the disks using a single-disk central control so as to perform online disk repair to the machines.

Specifically, for the storage-type service, because it is highly demanding on the redundancy and time-efficiency, if the whole-machine relocation maintenance is performed to the machine corresponding to the storage-type service, the redundancy and time-efficiency issues will arise, wherein the error maintaining module 103 performs online disk repair to the machines corresponding to the storage-type service, wherein the error maintaining module 103 performs online disk decommit and controls a disk decommit threshold through the single-disk central control, which avoids data loss caused by a considerable number of disks decommited, thereby guaranteeing service stability. Afterwards, the error maintaining module 103 performs online physical maintenance through the previous maintenance state machine.

Here, the error maintaining module 103 greatly enhances the committing rate and redundancy of the storage-type service by online detecting error disks and disk commit and decommit repair services, and by controlling disk decommit through a single-disk central control, avoids data loss caused by a considerable number of disk decommited, thereby guaranteeing service stability.

Here, the apparatus 1 collects software and/or hardware errors in a very large scale of machines; performs error analysis to the software and/or hardware errors to obtain corresponding error data; turns over respective states using a maintenance state machine based on the error data to complete automated maintenance of the very large scale of machines, wherein machines corresponding to the data that need to be relocated are subjected to whole-machine relocation maintenance, and the machines corresponding to a storage-type service are subjected to online disk repair. For a very large scale (tens of thousands, hundreds of thousands) of machines, the present disclosure provides a complete and automated maintenance system, which may satisfy error detection, service relocation, environment deployment, machine maintenance state turnover, fast handover, and etc. In the aspect of cost, the present disclosure reduces manpower for operation and maintenance and saves machines by enhancing turnover efficiency; in the aspect of full automation, the present disclosure realizes full automation in detection, maintenance, service relocation and deployment, without a need of human intervention; in the aspect of efficiency, the present disclosure has an efficient machine handover, which may achieve an hour-level or even minute-level handover.

Further, the apparatus 1 may satisfy system and environment supports in a plurality of scenarios and may also satisfy the scenarios of online machine maintaining and automated machine maintaining for transactions in an offline mixed deployment scenario. With the increasing number of machines, the present disclosure may also satisfy efficient machine turnover and handover, and satisfy transaction use; the present disclosure may be constantly horizontally scaled, and has a capability of quick handover, e.g., the capacity expansion may be completed at a minute level, reinstallation or rebooting may be completed at an hour level, and maintenance may be completed at a day level; moreover, the present disclosure may satisfy high-performance operations of tens of thousands of machines.

Preferably, the error collecting module 101 obtains the software and/or hardware errors based on the software detection and/or hardware detection on the very large scale of machines, and reports the software and/or hardware errors to a master service end (master end); wherein the error analyzing module 102 performs error analysis to the software and/or hardware errors stored in the master end, thereby obtaining corresponding error data.

Specifically, the error collecting module 101 obtains corresponding software errors and/or hardware errors based on the software detection and/or hardware detection on the very large scale of machines, e.g., the error collecting module 101 performs hardware detection on the very large scale of machines using an error detector (HAS) developed by Baidu, e.g., detecting hardware errors on the CPU, the disk, the RAM, etc.; or, the error collecting module 101 performs software detection on the very large scale of machines to detect system errors that seriously affect services, such as disk full, inode (file index error), drop disk, file system failure, and etc. Here, the error collecting module 101 may not only perform software detection on the very large scale of machines but also perform hardware detection; the hardware+software detection guarantees system stability more accurately. Afterwards, the error collecting module 101 reports the detected software errors and/or hardware errors to the master end. For example, summarizing the software errors and/or hardware errors detected in respective machines in the very large scale of machines, reporting them to the master end for storage.

Next, the error analyzing module 102 obtains the stored software and/or hardware errors from the master end and performs error analysis to these errors e.g., analyzing whether the respective machines are dead, whether heart beats exist, whether report-no exists, etc., thereby obtaining corresponding error data.

Those skilled in the art should understand that the manners of collecting the software and/or hardware errors in the very large scale of machines are only examples, and other existing or future possibly emerging manners of collecting software and/or hardware errors in the very large scale of machines, if applicable to the present invention, should also be included within the protection scope of the present disclosure, which are incorporated here by reference.

Preferably, the apparatus 1 further comprises an updating module (not shown). The updating module uses the error data obtained from performing error analysis to the software and/or hardware errors as an error source to establish or update a corresponding datacenter; wherein the error maintaining module 103 turns over respective states using the maintenance status machine based on the error source in the datacenter to thereby complete automated maintenance of the very large scale of machines.

Specifically, the updating module uses the error data obtained from performing error analysis to the software and/or hardware errors by error analyzing module 102 as the error source (for example, the error analyzing module 102 analyzes whether respective machines are dead, whether they have heart beat, whether report-no exists, etc., thereby obtaining corresponding error data); afterwards, the updating module stores these error data as an error source into a corresponding datacenter, so as to establish or update the datacenter; next, the error maintaining module 103 obtains the error source from the datacenter (e.g., obtaining the error source in the datacenter by invoking the corresponding application program interface (API) one or more times) and turns over respective states using the maintenance state machine based on the error source in the datacenter, thereby completing automated maintenance of the very large scale of machines.

Here, the datacenter stores various kinds of error sources. The datacenter may be located in the apparatus 1 or in a third-party device connected with the apparatus 1 over network; the updating module is connected with the datacenter over the network so as to store the error source into the datacenter; the error maintaining module 103 is connected with the datacenter over the network so as to obtain the error source from the datacenter.

Preferably, the error analyzing module 102 also classifies the error data obtained through error analysis to obtain classified error data; wherein the error maintaining module 103 turns over respective states using the maintenance state machine based on the classified error data, thereby completing automated maintenance of the very large scale of machines.

Specifically, the error analyzing module 102 performs error analysis to the software errors and/or hardware errors collected by the error collecting module 101 and classifies the error data obtained after error analysis, e.g., the error data may be classified as hw (hardware failure), sw (software failure), ssh.lost (crash), agent.lost (no heart beat), report-no-exists (no report-back information), etc., thereby obtaining the classified error data; or further, the error analyzing module 102 determines maintenance manners corresponding to respective error data and does classification on that basis. For example, if the error data is crash, its corresponding maintenance manner is reboot; if the error data is no heartbeat, its corresponding maintenance manner is reboot or reinstallation; if the error data is software error, e.g., disk full, its corresponding maintenance manner is reinstallation; if the error data is disk to-be-damaged or disk damaged, its corresponding maintenance manner is online disk repair, etc.; the error analyzing module 102 afterwards classifies them based on the maintenance manners corresponding to the respective error data; further, the error analyzing module 102, for example, may also label the maintenance manners corresponding to the respective error data. Here, the error data and their corresponding maintenance manners are only examples, and those skilled in the art may determine the maintenance manners corresponding to the error data according to practical operations. Other existing or future possibly emerging error data and their corresponding maintenance manners, if applicable to the present disclosure, should also be included within the protection scope of the present disclosure, and are incorporated here by reference.

Afterwards, the error maintaining module 103 turns over respective states for different classes of error data using the maintenance state machine based on the classified error data, thereby completing automated maintenance of the very large scale of machines, e.g., rebooting the machines corresponding to the class of error data that need reboot; reinstalling the machines corresponding to the class of error data that need reinstallation (e.g., first performing service relocation and then reinstallation); performing whole-machine relocation maintenance to the machines corresponding to hardware errors; for the disk-type errors, e.g., the disks will be damaged or have been damaged, performing online disk repair, etc.

Those skilled in the art should understand that the manners of analyzing and classifying the errors are only examples, and other existing or future possibly emerging manners of analyzing or classifying the errors, if applicable to the present disclosure, should also be included within the protection scope of the present disclosure, which are incorporated here by reference.

A preferred embodiment is provided below:

The automated maintenance system mainly comprises a plurality of important system services: error analysis system, maintenance status machine, general relocation service, online disk repair service, etc.

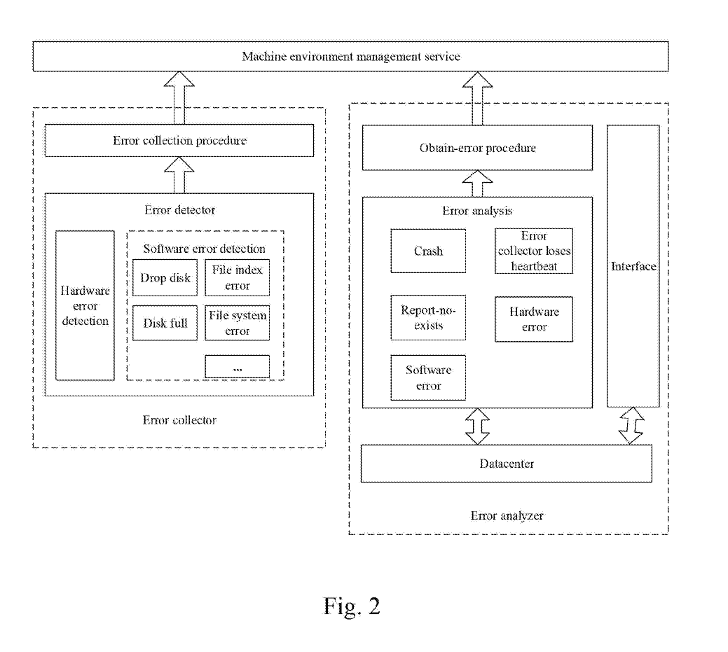

Particularly, the error analysis system consists of two parts: collect (error collector, error-report) and parse service (error analyzer, parse-report). Its specific architecture diagram is shown in FIG. 2.

Error-report is an error collector. The error collecting module 101 as mentioned above separately performs hardware error collection and software error collection and then summarizes the original information to report to the bios-master end (machine environment management service), wherein the hardware error collector may detect hardware errors such as CPU, disk, RAM with an error detector (HAS) developed by Baidu; the software error collector for example may be developed by the system itself, which detects system errors that serious affect services, such as disk full, inode (file index error), drop disk; the hardware+software detection guarantees system stability more accurately.

Parse-report is an error analyzer, mainly for processing the source data collected by error-report, like the error analyzing module 102 mentioned above, and then analyzing at the service end (including classifying and grading the errors, and other processing), and also analyzing whether the machines are dead; and finally persisting the analyzed error data as an error source into the datacenter for query and using by the maintenance state machine.

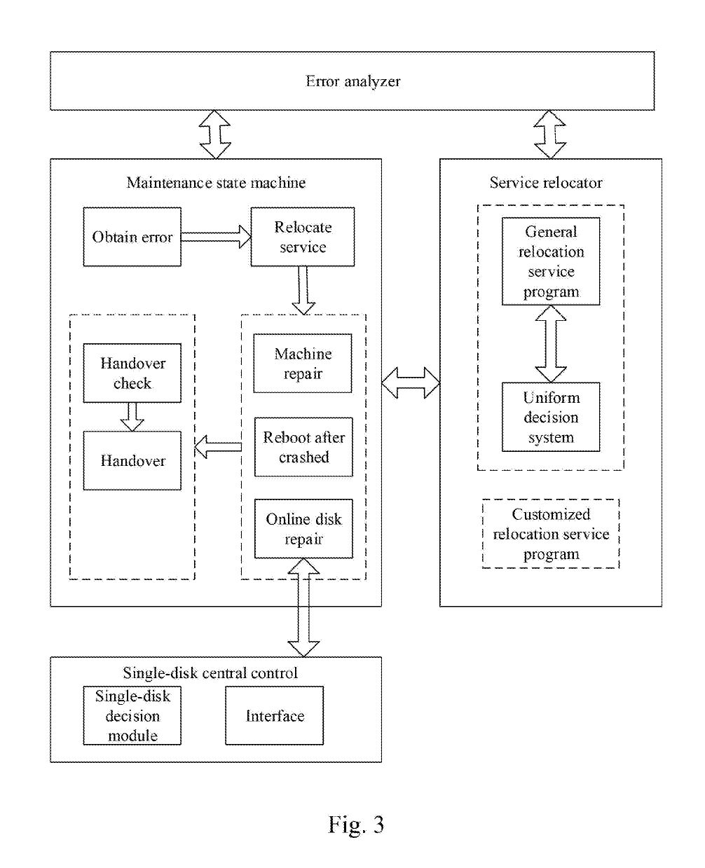

The maintenance status machine mainly plays two important roles: one is ensuring state turnover to guarantee corresponding processing to various states; the other is performing threshold control, skipping and the other contents through a general configuration description, wherein the state turnover of the state machine mainly refers to performing skipping to procedures of the machine cycle, e.g., error, maintenance, handover, etc.; for details, please refer to FIG. 3. For example, obtaining error (ERROR)->relocation service (DECOMMITTING, DECOMMITTED->repair (machine repair+reboot+online disk repair)->handover->handover check; obtaining errors through an error source (e.g., the error analyzer or the corresponding datacenter mentioned before), and then finally completing automated machine repair based on turnover of the state machine for various states. The procedures and states specifically maintained by the maintenance state machine are similar to what have been discussed in the error maintaining module 103, which will not be detailed here, but are incorporated herein by reference.

Particularly, service callback employs a general relocation service platform, which, after detecting an error, informs the transaction system relocation service to make a decision; only the service is relocated, can the maintenance flow be conducted, which ensures stability of the service and avoids an occasion that each of different transactions needs to maintain an independent set of relocation services. The general platform may designate a uniform rule and a uniform policy so as to facilitate access and maintenance.

By collecting errors through the error analyzer or the corresponding datacenter, triggering online disk decommit, controlling a disk decommit threshold through a single-disk central control to ensure service stability, and then performing online physical repair through the state machine, the online disk repair service greatly improves the committing rate and redundancy of the storage service, and by controlling the disk decommit through the central control service, it avoids data loss caused by a considerable numbers of disk decommits.

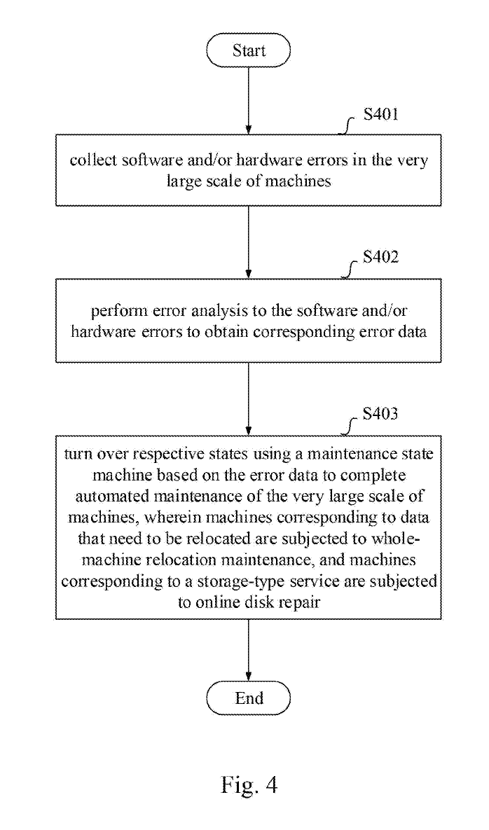

FIG. 4 shows a flow diagram of a method for automatically maintaining a very large scale of machines according to another aspect of the present disclosure.

In step S401, the apparatus 1 collects software and/or hardware errors in a very large scale of machines.

Specifically, in step S401, the apparatus 1 for example directly obtains the software errors and/or hardware errors of the very large scale of machines directly from a predetermined location, e.g., an error datacenter or other third-party devices; or, in step S401, the apparatus 1 detects the respective machines constituting the very large scale of machines, e.g., by performing software detection and hardware detection to the respective machines, to detect whether the CPUs, disks, RAMs and the like are healthy or detect whether the disks are already full, whether a disk drops, whether a file system fails, etc., thereby collecting software errors and/or hardware errors in the very large scale of machines.

In step S402, the apparatus 1 performs error analysis to the software and/or hardware errors to obtain corresponding error data.

Specifically, in step S402, the apparatus 1 performs error analysis to these errors based on the software errors and/or hardware errors collected in step S401, e.g., analyzing whether the respective machines crash, whether heart beats exist, whether report-no exists, etc., thereby obtaining corresponding error data.

In step S403, the apparatus 1 turns over respective states using a maintenance state machine based on the error data to complete automated maintenance of the very large scale of machines, wherein machines corresponding to the data that need to be relocated are subjected to whole-machine relocation maintenance, while the machines corresponding to the storage-type services are subjected to online disk repair.

Specifically, in step S403, the apparatus 1 employs a maintenance state machine to turn over respective states based on the error data obtained from the analysis in step S402, thereby completing automated maintenance of the very large scale of machines, e.g., turning over respective states such as the machine's crash state, error state, and normal service state, etc., and then performing skipping to respective procedures for the very large scale of machines, e.g., performing skipping to procedures such as error, maintenance, and handover. Particularly, the machines corresponding to the data that need to be relocated are subjected to whole-machine relocation maintenance; because some errors require relocation of the machine where they are located for repairing the remained machines, in step S403, the apparatus 1 relocates the machines corresponding to the data that need relocation and performs whole-machine maintenance to the relocated machine. For a storage-type service, because it is highly demanding on the redundancy and time-efficiency, if a machine corresponding to the storage-type service is subjected to whole-machine relocation maintenance, redundancy and time-efficiency issues will exist; therefore, in step S403, the apparatus 1 performs online disk repair to the machines corresponding to the storage-type service.

Here, the maintenance state machine mainly performs skipping to procedures of machine cycle, e.g., error, maintenance, and handover, etc., wherein the maintenance state machine maintains a plurality of states, e.g., ERROR, DEAD, DECOMMITTING, DECOMMMITED, OS_INSTALL (REBOOT), BURNING, HANDOVER_CHECK, ABNORMAL, COMMITTING, ACTIVE, and etc.; the various states above are used for indicating states of machines in various periods, specifically:

ERROR| DEAD: when an error occurs to a machine, the error will be obtained from the step S402; then the maintenance state machine skips to Error, and in the case of crash, skips to DEAD;

DECOMMITTING and DECOMMITTED: it mainly relates to service relocation, for guaranteeing service safety and assigning tasks for errors, e.g., reboot, reinstall, maintenance, etc.

OS_INSTALL (REBOOT): a procedure state for reinstallation or rebooting;

BURNING: a process of environment recovery after reinstallation or rebooting, generally referred to as an initialization environment;

HANDOVER_CHECK and ABNORMAL: HANDOVER_CHECK mainly refers to a secondary check behavior to detect whether a repaired machine still has an error; if the machine is not repaired well, continue to reinstall or reboot. ABNORMAL refers to entering into a manual processing stage if the machine is still not repaired well after exceeding predetermined times.

COMMITTING and ACTIVE: COMMITTING refers to committing the relocated service when no problem is found through handover check and setting the machine to normal ACTIVE.

Here, in step S403, the apparatus 1 controls the states of respective procedures through the maintenance state machine to process different stages, and controls switching between various states through state description, safety protection threshold, retry times, and other contents. The state description is mainly for general processing, suitable for scenarios of various transactions, and thus is a set of state machine adapter. An example of state description is provided below:

state:

ACTIVE:

- action: check_active
dst_state:

- ACTIVE
- DEAD
- ERROR

DEAD:

- action: decommit_host
dst_state: DECOMMITTING

...

thresholds:

state_thresholds:

DECOMMITTED:

threshold: 200
throughput: 100

....

In the table above, state describes a state of the maintenance state machine, e.g., ACTIVE refers to a normal service state; —action refers to an operation in the state processing procedure, e.g., check active refers to checking whether the machine is normal;

dst_state refers to skipping to different target states according to different returned value states in the action so as to control turnover of the maintenance state machine; in the case of crash, skip to DEAD; in the case of error, skip to ERROR.

Preferably, in step S403, the apparatus 1 turns over the respective states using a maintenance state machine based on the error data in conjunction with the threshold corresponding to the configuration information, thereby completing automated maintenance of the very large scale of machines.

For example, in the example of the state description, thresholds are used for controlling thresholds, wherein for controlling the assigned decommitted maintenance, throughput: 100 indicates that the assignment value is controlled not to exceed 100 machines; in the case of exceeding 100 machines, status skipping will not be performed, thereby ensuring safety of the service. Similarly, in step S403, the apparatus 1 may also turn over respective states using the maintenance state machine based on the error data in conjunction with the threshold corresponding to other configuration information, thereby completing automated maintenance of the very large scale of machines.

Those skilled in the art should understand that the threshold and its value are only exemplary; other existing or future possibly emerging thresholds and their values, if applicable to the present disclosure, should also be included within the protection scope of the present disclosure, which are incorporated here by reference.

Preferably, in step S403, the apparatus 1 performs a whole-machine relocation maintenance to the machines corresponding to the data that need to be relocated using a general relocation service platform; for the machines remained after relocation, the maintenance status machine continues turning over respective states to perform automated maintenance.

Specifically, some errors require relocating the machines where they are located so as to maintain the remained machines. Therefore, in step S403, the apparatus 1 relocates the machines corresponding to the data that need to be relocated using a general relocation service platform and performs whole-machine maintenance to the relocated machines. Here, use of the general relocation service platform avoids an occasion that each transaction in different transactions requires maintaining an independent set of relocation services; the general relocation service platform may designate a uniform rule and a uniform policy to facilitate access and maintenance, which is extremely essential for the very large-scale cluster system. Afterwards, in step S403, the apparatus 1 continues using the maintenance state machine for the machines remained after relocation so as to turn over respective states, thereby completing automated maintenance of the very large scale of machines.

Here, in step S403, the apparatus 1 only performs the maintenance procedure after the relocation of service, thereby guaranteeing service stability.

Preferably, for machines corresponding to the storage-type service, in step S403, the apparatus 1 decides whether to decommit the disks using a single-disk central control so as to perform online disk repair to the machines.

Specifically, for the storage-type service, because it is highly demanding on the redundancy and time-efficiency, if the whole-machine relocation maintenance is performed to the machine corresponding to the storage-type service, the redundancy and time-efficiency issues will arise, wherein in step S403, the apparatus 1 performs online disk repair to the machines corresponding to the storage-type service, wherein in step S403, the apparatus 1 performs online disk decommit and controls a disk decommit threshold through the single-disk central control, which avoids data loss caused by a considerable number of disks decommited, thereby guaranteeing service stability. Afterwards, in step S403, the apparatus 1 performs online physical maintenance through the previous maintenance state machine.

Here, in step S403, the apparatus 1 greatly enhances the committing rate and redundancy of the storage-type service by online detecting error disks and disk commit and decommit repair services, and by controlling disk decommit through a single-disk central control, avoids data loss caused by a considerable number of disk decommited, thereby guaranteeing service stability.

Here, the apparatus 1 collects software and/or hardware errors in a very large scale of machines; performs error analysis to the software and/or hardware errors to obtain corresponding error data; turns over respective states using a maintenance state machine based on the error data to complete automated maintenance of the very large scale of machines, wherein machines corresponding to the data that need to be relocated are subjected to whole-machine relocation maintenance, and the machines corresponding to a storage-type service are subjected to online disk repair. For a very large scale (tens of thousands, hundreds of thousands) of machines, the present disclosure provides a complete and automated maintenance system, which may satisfy error detection, service relocation, environment deployment, machine maintenance state turnover, fast handover, and etc. In the aspect of cost, the present disclosure reduces manpower for operation and maintenance and saves machines by enhancing turnover efficiency; in the aspect of full automation, the present disclosure realizes full automation in detection, maintenance, service relocation and deployment, without a need of human intervention; in the aspect of efficiency, the present disclosure has an efficient machine handover, which may achieve an hour-level or even minute-level handover.

Further, the apparatus 1 may satisfy system and environment supports in a plurality of scenarios and may also satisfy the scenarios of online machine maintaining and automated machine maintaining for transactions in an offline mixed deployment scenario. With the increasing number of machines, the present disclosure may also satisfy efficient machine turnover and handover, and satisfy transaction use; the present disclosure may be constantly horizontally scaled, and has a capability of quick handover, e.g., the capacity expansion may be completed at a minute level, reinstallation or rebooting may be completed at an hour level, and maintenance may be completed at a day level; moreover, the present disclosure may satisfy high-performance operations of tens of thousands of machines.

Preferably, in step S401, the apparatus 1 obtains the software and/or hardware errors based on the software detection and/or hardware detection on the very large scale of machines, and reports the software and/or hardware errors to a master service end (master end); wherein in step S402, the apparatus 1 performs error analysis to the software and/or hardware errors stored in the master end, thereby obtaining corresponding error data.

Specifically, in step S401, the apparatus 1 obtains corresponding software errors and/or hardware errors based on the software detection and/or hardware detection on the very large scale of machines, e.g., in step S401, the apparatus 1 performs hardware detection on the very large scale of machines using an error detector (HAS) developed by Baidu, e.g., detecting hardware errors on the CPU, the disk, the RAM, etc.; or, in step S401, the apparatus 1 performs software detection on the very large scale of machines to detect system errors that seriously affect services, such as disk full, inode (file index error), drop disk, file system failure, and etc. Here, in step S401, the apparatus 1 may not only perform software detection on the very large scale of machines but also perform hardware detection; the hardware+software detection guarantees system stability more accurately. Afterwards, in step S401, the apparatus 1 reports the detected software errors and/or hardware errors to the master end. For example, summarizing the software errors and/or hardware errors detected in respective machines in the very large scale of machines, reporting them to the master end for storage.

Next, in step S402, the apparatus 1 obtains the stored software and/or hardware errors from the master end and performs error analysis to these errors e.g., analyzing whether the respective machines are dead, whether heart beats exist, whether report-no exists, etc., thereby obtaining corresponding error data.

Those skilled in the art should understand that the manners of collecting the software and/or hardware errors in the very large scale of machines are only examples, and other existing or future possibly emerging manners of collecting software and/or hardware errors in the very large scale of machines, if applicable to the present invention, should also be included within the protection scope of the present disclosure, which are incorporated here by reference.

Preferably, the method further comprises a step S404 (not shown). In step S404, the apparatus 1 uses the error data obtained from performing error analysis to the software and/or hardware errors as an error source to establish or update a corresponding datacenter; wherein in step S403, the apparatus 1 turns over respective states using the maintenance status machine based on the error source in the datacenter to thereby complete automated maintenance of the very large scale of machines.

Specifically, in step S404, the apparatus 1 uses the error data obtained from performing error analysis to the software and/or hardware errors in step S402 as the error source (for example, in step S402, the apparatus 1 analyzes whether respective machines are dead, whether they have heart beat, whether report-no exists, etc., thereby obtaining corresponding error data); afterwards, in step S404, the apparatus 1 stores these error data as an error source into a corresponding datacenter, so as to establish or update the datacenter; next, in step S403, the apparatus 1 obtains the error source from the datacenter (e.g., obtaining the error source in the datacenter by invoking the corresponding application program interface (API) one or more times) and turns over respective states using the maintenance state machine based on the error source in the datacenter, thereby completing automated maintenance of the very large scale of machines.

Here, the datacenter stores various kinds of error sources. The datacenter may be located in the apparatus 1 or in a third-party device connected with the apparatus 1 over network; in step S404, the apparatus 1 is connected with the datacenter over the network so as to store the error source into the datacenter; in step S403, the apparatus 1 is connected with the datacenter over the network so as to obtain the error source from the datacenter.

Preferably, in step S402, the apparatus 1 also classifies the error data obtained through error analysis to obtain classified error data; wherein in step S403, the apparatus 1 turns over respective states using the maintenance state machine based on the classified error data, thereby completing automated maintenance of the very large scale of machines.

Specifically, in step S402, the apparatus 1 performs error analysis to the software errors and/or hardware errors collected in step S401 and classifies the error data obtained after error analysis, e.g., the error data may be classified as hw (hardware failure), sw (software failure), ssh.lost (crash), agent.lost (no heart beat), report-no-exists (no report-back information), etc., thereby obtaining the classified error data; or further, in step S402, the apparatus 1 determines maintenance manners corresponding to respective error data and does classification on that basis. For example, if the error data is crash, its corresponding maintenance manner is reboot; if the error data is no heartbeat, its corresponding maintenance manner is reboot or reinstallation; if the error data is software error, e.g., disk full, its corresponding maintenance manner is reinstallation; if the error data is disk to-be-damaged or disk damaged, its corresponding maintenance manner is online disk repair, etc.; the error analyzing module 102 afterwards classifies them based on the maintenance manners corresponding to the respective error data; further, in step S402, the apparatus 1, for example, may also label the maintenance manners corresponding to the respective error data. Here, the error data and their corresponding maintenance manners are only examples, and those skilled in the art may determine the maintenance manners corresponding to the error data according to practical operations. Other existing or future possibly emerging error data and their corresponding maintenance manners, if applicable to the present disclosure, should also be included within the protection scope of the present disclosure, and are incorporated here by reference.

Afterwards, in step S403, the apparatus 1 turns over respective states for different classes of error data using the maintenance state machine based on the classified error data, thereby completing automated maintenance of the very large scale of machines, e.g., rebooting the machines corresponding to the class of error data that need reboot; reinstalling the machines corresponding to the class of error data that need reinstallation (e.g., first performing service relocation and then reinstallation); performing whole-machine relocation maintenance to the machines corresponding to hardware errors; for the disk-type errors, e.g., the disks will be damaged or have been damaged, performing online disk repair, etc.

Those skilled in the art should understand that the manners of analyzing and classifying the errors are only examples, and other existing or future possibly emerging manners of analyzing or classifying the errors, if applicable to the present disclosure, should also be included within the protection scope of the present disclosure, which are incorporated here by reference.

Preferably, the present disclosure also provides a computer device, comprising one or more processors and memories. The memory is used for storing one or more computer programs. When the one or more computer programs are executed by the one or more processors, the one or more processors are caused to implement the method according to any one of steps S401-S404.

It should be noted that the present disclosure may be implemented in software or a combination of software and hardware; for example, it may be implemented by a dedicated integrated circuit (ASIC), a general-purpose computer, or any other similar hardware device. In an embodiment, the software program of the present disclosure may be executed by a processor so as to implement the above steps or functions. Likewise, the software program of the present disclosure (including relevant data structure) may be stored in a computer readable recording medium, for example, a RAM memory, a magnetic or optical driver, or a floppy disk, and similar devices. Besides, some steps of functions of the present disclosure may be implemented by hardware, for example, a circuit cooperating with the processor to execute various functions or steps.

To those skilled in the art, it is apparent that the present disclosure is not limited to the details of the above exemplary embodiments, and the present disclosure may be implemented with other forms without departing from the spirit or basic features of the present disclosure. Thus, in any way, the embodiments should be regarded as exemplary, not limitative; the scope of the present disclosure is limited by the appended claims, instead of the above depiction. Thus, all variations intended to fall into the meaning and scope of equivalent elements of the claims should be covered within the present disclosure. No reference signs in the claims should be regarded as limiting the involved claims. Besides, it is apparent that the term “comprise/comprising/include/including” does not exclude other units or steps, and singularity does not exclude plurality. A plurality of units or means stated in the apparatus claims may also be implemented by a single unit or means through software or hardware. Terms such as the first and the second are used to indicate names, but do not indicate any particular sequence.

What is claimed is:

1. A method for automatically maintaining a very large scale of machines, the method comprising:
collecting software and/or hardware errors in the very large scale of machines;
performing error analysis to the software and/or hardware errors to obtain corresponding error data; and
turning over respective states using a maintenance state machine based on the error data to complete automated maintenance of the very large scale of machines, wherein machines corresponding to data that need to be relocated are subjected to whole-machine relocation maintenance, and machines corresponding to a storage-type service are subjected to online disk repair.

2. The method according to claim 1, wherein the collecting software and/or hardware errors in the very large scale of machines comprises:
obtaining the software and/or hardware errors based on software detection and/or hardware detection on the very large scale of machines, and reporting the software and/or hardware errors to a master service end;
wherein, the performing error analysis to the software and/or hardware errors to obtain corresponding error data comprises:
performing error analysis to the software and/or hardware errors in the master service end to obtain corresponding error data.

3. The method according to claim 1, wherein the method further comprises:
establishing or updating a corresponding data center using the error data obtained from performing error analysis to the software and/or hardware errors as an error source;
wherein, the turning over respective states using a maintenance state machine based on the error data to complete automated maintenance of the very large scale of machines comprises:
turning over respective states using the maintenance state machine based on the error source in the datacenter to complete automated maintenance of the very large scale of machines.

4. The method according to claim 1, wherein the performing error analysis to the software and/or hardware errors to obtain corresponding error data further comprises:
classifying the error data obtained through the error analysis to obtain classified error data;
wherein, the performing error analysis to the software and/or hardware errors to obtain corresponding error data comprises:
turning over respective states using the maintenance state machine based on the classified error data to complete automated maintenance of the very large scale of machines.

5. The method according to claim 1, wherein the turning over respective states using a maintenance state machine based on the error data to complete automated maintenance of the very large scale of machines comprises:
turning over respective states using the maintenance state machine based on the classified error data in conjunction with a threshold corresponding to configuration information to complete automated maintenance of the very large scale of machines.

6. The method according to claim 1, wherein the turning over respective states using a maintenance state machine based on the error data to complete automated maintenance of the very large scale of machines comprises:
performing whole-machine relocation maintenance to machines corresponding to the data that need to be relocated using a general relocation service platform; and
for the machines remained after relocation, continuing turning over respective states using the maintenance state machine to perform automated maintenance.

7. The method according to claim 1, wherein the turning over respective states using a maintenance state machine based on the error data to complete automated maintenance of the very large scale of machines comprises:
for the machines corresponding to a storage-type service, deciding whether to decommit disks using a single-disk central control, so as to perform online disk repair to the machines.

8. An apparatus for automatically maintaining a very large scale of machines, the apparatus comprising:
at least one processor; and
a memory storing instructions, the instructions when executed by the at least one processor, cause the at least one processor to perform operations, the operations comprising:
collecting software and/or hardware errors in the very large scale of machines;
performing error analysis to the software and/or hardware errors to obtain corresponding error data; and
turning over respective states using a maintenance state machine based on the error data to complete automated maintenance of the very large scale of machines, wherein machines corresponding to data that need to be relocated are subjected to whole-machine relocation maintenance, and machines corresponding to a storage-type service are subjected to online disk repair.

9. The apparatus according to claim 8, wherein the collecting software and/or hardware errors in the very large scale of machines comprises:
obtaining the software and/or hardware errors based on software detection and/or hardware detection on the very large scale of machines, and reporting the software and/or hardware errors to a master service end;
wherein, the performing error analysis to the software and/or hardware errors to obtain corresponding error data comprises:
performing error analysis to the software and/or hardware errors in the master service end to obtain corresponding error data.

10. The apparatus according to claim 8, wherein the operations further comprise:
establishing or updating a corresponding data center using the error data obtained from performing error analysis to the software and/or hardware errors as an error source;
wherein, the turning over respective states using a maintenance state machine based on the error data to complete automated maintenance of the very large scale of machines comprises:
turning over respective states using the maintenance state machine based on the error source in the datacenter to complete automated maintenance of the very large scale of machines.

11. The apparatus according to claim 9, wherein the performing error analysis to the software and/or hardware errors to obtain corresponding error data further comprises:
classifying the error data obtained through the error analysis to obtain classified error data;
wherein, the performing error analysis to the software and/or hardware errors to obtain corresponding error data comprises:
turning over respective states using the maintenance state machine based on the classified error data to complete automated maintenance of the very large scale of machines.

12. The apparatus according to claim 8, wherein the turning over respective states using a maintenance state machine based on the error data to complete automated maintenance of the very large scale of machines comprises:
turning over respective states using the maintenance state machine based on the classified error data in conjunction with a threshold corresponding to configuration information to complete automated maintenance of the very large scale of machines.

13. The apparatus according to claim 8, wherein the turning over respective states using a maintenance state machine based on the error data to complete automated maintenance of the very large scale of machines comprises:
performing whole-machine relocation maintenance to machines corresponding to the data that need to be relocated using a general relocation service platform; and
for the machines remained after relocation, continuing turning over respective states using the maintenance state machine to perform automated maintenance.

14. The apparatus according to claim 8, wherein the turning over respective states using a maintenance state machine based on the error data to complete automated maintenance of the very large scale of machines comprises:
for the machines corresponding to a storage-type service, deciding whether to decommit disks using a single-disk central control, so as to perform online disk repair to the machines.

15. A non-transitory computer storage medium storing a computer program, the computer program when executed by one or more processors, causes the one or more processors to perform operations, the operations comprising:
collecting software and/or hardware errors in the very large scale of machines;
performing error analysis to the software and/or hardware errors to obtain corresponding error data; and
turning over respective states using a maintenance state machine based on the error data to complete automated maintenance of the very large scale of machines, wherein machines corresponding to data that need to be relocated are subjected to whole-machine relocation maintenance, and machines corresponding to a storage-type service are subjected to online disk repair.
